(19) United States
(12) Patent Application Publication
(10) Pub. No.: US 2014/0004733 A1
(43) Pub. Date: Jan. 2, 2014

(54) TELEVISION RECEIVER, ELECTRONIC APPARATUS, AND CONNECTOR

(71) Applicant: KABUSHIKI KAISHA TOSHIBA, Tokyo (JP)

(72) Inventors: Masaya Hirashima, Ome-shi (JP); Tsuyoshi Kozai, Ome-shi (JP)

(73) Assignee: KABUSHIKI KAISHA TOSHIBA, Tokyo (JP)

(21) Appl. No.: 13/971,614

(22) Filed: Aug. 20, 2013

Related U.S. Application Data
(63) Continuation of application No. PCT/JP2013/058184, filed on Mar. 14, 2013.

(30) Foreign Application Priority Data
Jun. 29, 2012 (JP) 2012-146769

(51) Int. Cl. H01R 13/627

(52) U.S. Cl. CPC H01R 13/6271
USPC 439/358

(57) ABSTRACT

According to one embodiment, a television receiver includes: a housing including a first opening and a second opening; a display in the housing, the display including a display surface exposed through the first opening; a circuit board in the housing; and a connector on the circuit board, exposed through the second opening, an external connector configured to be inserted into the connector, wherein the connector includes: a terminal configured to be electrically connected to the external connector; a base portion as a separate member from the housing, the base portion including an electrically insulated holder holding the terminal; and a second hook as a part of the housing, a first hook of the external connector configured to engage with the second hook.

### CROSS-REFERENCE TO RELATED APPLICATIONS

This application is a continuation of PCT international application Ser. No. PCT/JP2013/058184, filed on Mar. 14, 2013, which designates the United States, incorporated herein by reference, and which is based upon and claims the benefit of priority from Japanese Patent Application No. 2012-146769, filed on Jun. 29, 2012, the entire contents of which are incorporated herein by reference.

### FIELD

Embodiments described herein relate generally to a television receiver, an electronic apparatus, and a connector.

### BACKGROUND

Conventionally widely known are electronic apparatuses comprising a housing, a circuit board housed in the housing, and a connector mounted on the circuit board.

This kind of electronic apparatuses, such as television receivers, are desired to be downsized.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of a television receiver according to a first embodiment;

FIG. 2 is an exemplary side view of the television receiver in the first embodiment;

FIG. 3 is an exemplary view of a part of a section along F3-F3 in FIG. 1;

FIG. 4 is an exemplary view of a part of a section along F4-F4 in FIG. 1;

FIG. 5 is an exemplary arrow view of a part of the television receiver in the first embodiment viewed from an F5 direction in FIG. 2;

FIG. 6 is an exemplary perspective view of an external connector in the first embodiment;

FIG. 7 is an exemplary sectional view of a part corresponding to FIG. 3 of a television receiver according to a first modification of the first embodiment;

FIG. 8 is an exemplary sectional view of a part corresponding to FIG. 3 of a television receiver according to a second modification of the first embodiment;

FIG. 9 is an exemplary sectional view of a part corresponding to FIG. 3 of a television receiver according to a third modification of the first embodiment;

FIG. 10 is an exemplary sectional view of a part corresponding to FIG. 3 of a television receiver according to a fourth modification of the first embodiment;

FIG. 11 is an exemplary sectional view of a part corresponding to FIG. 3 of a television receiver according to a fifth modification of the first embodiment;

FIG. 12 is an exemplary sectional view of a part corresponding to FIG. 3 of a television receiver according to a sixth modification of the first embodiment;

FIG. 13 is an exemplary perspective view of an electronic apparatus according to a second embodiment in an unfolded state;

FIG. 14 is an exemplary plan view of the electronic apparatus in the second embodiment in a folded state;

FIG. 15 is an exemplary side view of the electronic apparatus in the second embodiment in the folded state;

FIG. 16 is an exemplary view illustrating a state where an external connector is attached to the electronic apparatus in the second embodiment on a section along F16-F16 in FIG. 15;

FIG. 17 is an exemplary perspective view of an electronic apparatus according to a third embodiment in an unfolded state viewed from the back; and

FIG. 18 is an exemplary view of a part of a section along F18-F18 in FIG. 17.

### DETAILED DESCRIPTION

In general, according to one embodiment, a television receiver comprises: a housing comprising a first opening and a second opening; a display in the housing, the display comprising a display surface exposed through the first opening; a circuit board in the housing; and a connector on the circuit board, exposed through the second opening, an external connector configured to be inserted into the connector, wherein the connector comprises: a terminal configured to be electrically connected to the external connector; a base portion as a separate member from the housing, the base portion comprising an electrically insulated holder holding the terminal; and a second hook as a part of the housing, a first hook of the external connector configured to engage with the second hook.

Exemplary embodiments and modifications described below comprise components similar to one another. In the description below, similar components are represented by common reference numerals, and a repetitive explanation thereof will be omitted.

In the embodiments below, while an electronic apparatus is embodied as a television receiver and a so-called notebook personal computer, for example, the electronic apparatus according to the present embodiment is not limited thereto. The electronic apparatus according to the present embodiment, for example, can be embodied as an electronic apparatus comprising a connector, such as a smart television, a mobile phone, a video display, and a video phone.

### First Embodiment

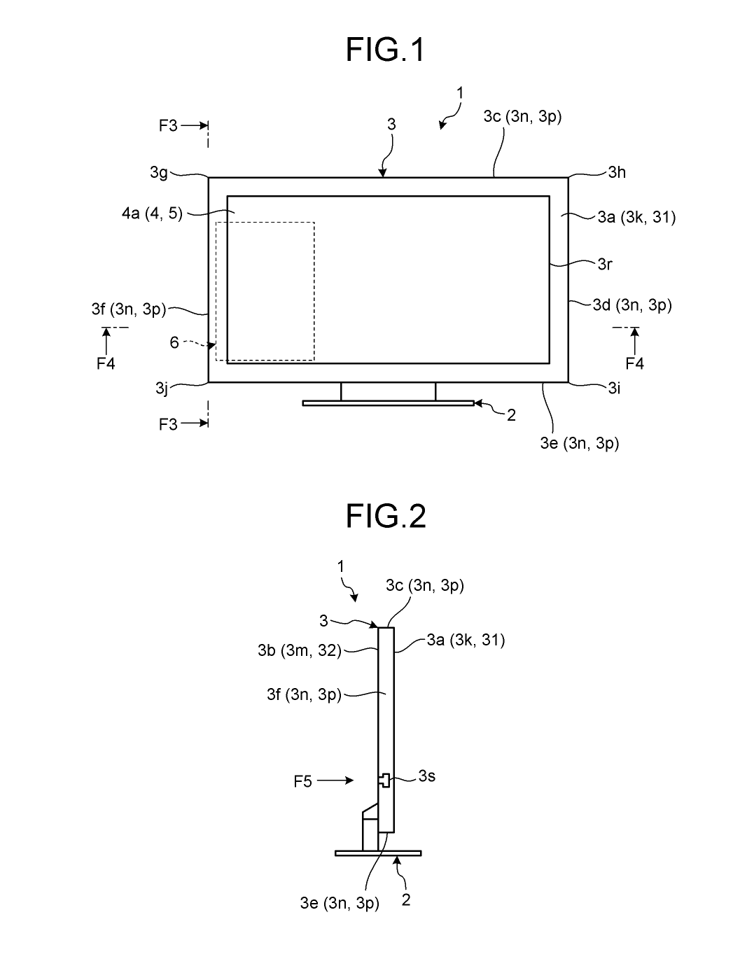

In a first embodiment, as illustrated in FIG. 1 and FIG. 2, a television receiver 1 comprises a support 2 and a housing 3, for example. Specifically, the housing 3 (a first housing, a first part, or a first component) houses at least a part of a display 4. The support 2 (a stand portion, a stand, a supporting portion, a second housing, a second part, another part, or another component) supports the housing 3. The support 2 is placed on an external placing surface (a flat surface or a horizontal surface).

In the first embodiment, for example, the support 2 rotatably supports the housing 3 via a hinge (a connecting portion, a coupling portion, a rotational supporting portion, a hinge mechanism, a connecting mechanism, a coupling mechanism, or a rotational supporting mechanism). In other words, the hinge rotatably connects (couples) the support 2 and the housing 3. In the first embodiment, for example, the hinge changes the angle of a display screen 4a in the vertical direction. In other words, the hinge can adjust a tilt. The support 2 can support the housing 3 rotatably in another direction (e.g., pivot or swivel).

In the first embodiment, as illustrated in FIG. 1, the housing 3 of the television receiver 1 is formed in a rectangular shape (an oblong shape in the first embodiment, for example) viewed from the front and the back, for example. Furthermore, in the first embodiment, as illustrated in FIG. 2, the housing 3 is formed in a flat rectangular parallelepiped shape that has a small width in the front-back direction, for example. The housing 3 comprises a surface 3a (a front surface, a face, a first surface, or a first surface portion) and a surface 3b (a rear surface, a back surface, a second surface, or a second surface portion) opposite thereto. The surface 3a and the surface 3b are nearly parallel to each other. Furthermore, as illustrated in FIG. 1, the housing 3 comprises four ends 3c to 3f (sides or edges) and four corners 3g to 3j (peaks, curves, or ends) viewed from the front. The ends 3c and 3e are examples of a long side. The ends 3d and 3f are examples of a short side.

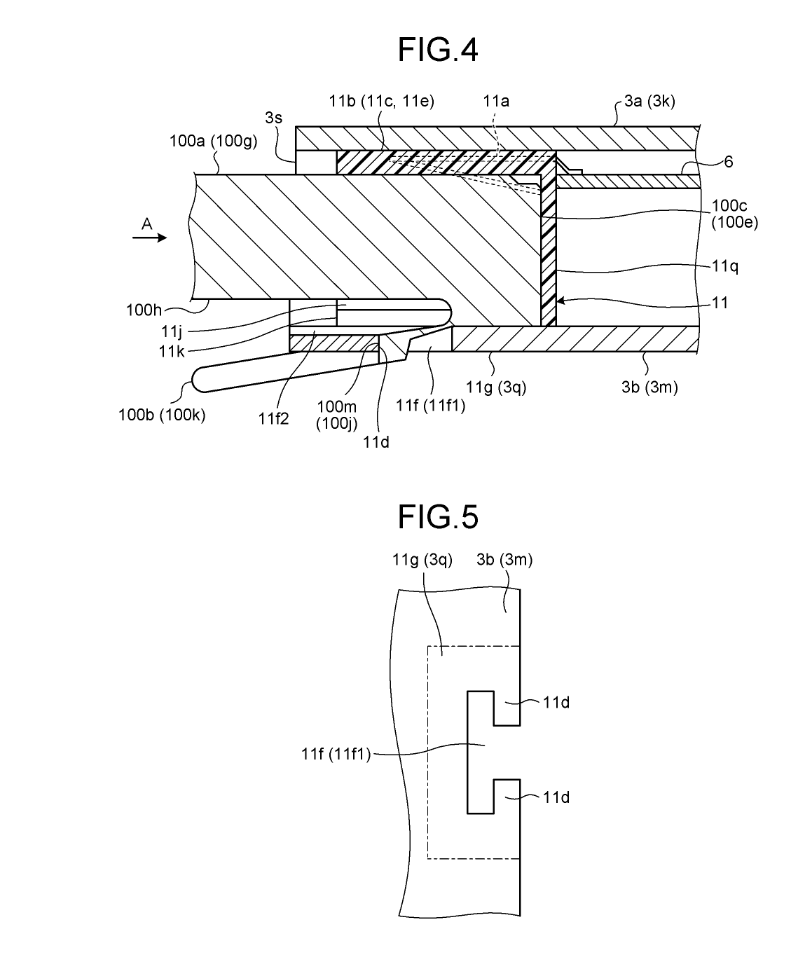

The housing 3 further comprises a wall 3k (a plate, a frame, a front wall, a face wall, or a top wall) comprising the surface 3a and a wall 3m (a plate, a rear wall, a back wall, or a bottom wall, refer to FIG. 2) comprising the surface 3b. The walls 3k and 3m are in a rectangular shape (an oblong shape in the first embodiment, for example). Furthermore, the housing 3 comprises four walls 3n (third parts, plates, side walls, end walls, standing walls, or extending portions) comprising a surface 3p (a side surface, a peripheral surface, or a third surface) extending between the wall 3k and the wall 3m. The wall 3k has an opening 3r (a first opening) in a rectangular shape, for example. Therefore, the wall 3k is in a rectangular shape and a frame shape. In the first embodiment, the wall 3m is an example of a first wall (a first part) provided with a hook 11d (a second hook, refer to FIG. 4), which will be described later, and the wall 3k is an example of a second wall (a second part) facing the wall 3m (first wall) with a space interposed therebetween.

Furthermore, the housing 3 can be formed by combining a plurality of components (divided parts). In the first embodiment, for example, the housing 3 comprises a first housing member 31 (a first part, a front side member, a mask, a mask portion, a cover, a front cover, a cover portion, or a first area) having at least the wall 3k and a second housing member 32 (a second part, a rear side member, a base, a base portion, a bottom, a bottom portion, a cover, a rear cover, a cover portion, or a second area) having at least the wall 3m. The wall 3n is comprised in at least one of the first housing member 31 and the second housing member 32 (e.g., in the second housing member 32). In addition to the first housing member 31 and the second housing member 32, the housing 3 can comprise a third housing member (a third part, a middle member, a dividing member, a barrier member, a wall member, an intervening member, an inner plate, a middle plate, a middle frame, or a third area, which is not illustrated), a fourth housing member (a fourth part, a middle member, a dividing member, a barrier member, a wall member, an intervening member, a covering member, a shield, or a fourth area, which is not illustrated), and the like arranged between the first housing member 31 and the second housing member 32.

The housing 3 can be made of a metal material and a synthetic resin material, for example. The first housing member 31 and the second housing member 32 can be made of a material having relatively low rigidity (a material having lower rigidity than those of the third housing member and the fourth housing member, such as a synthetic resin material). Surfaces of the first housing member 31 and the second housing member 32 facing the inside of the housing 3 can be provided with a wall such as a rib (a protruding portion or a protruding wall, which is not illustrated). The wall can increase the rigidity of the housing 3.

In the first embodiment, as illustrated in FIG. 1, the display screen 4a arranged on the surface 3a side of the display (a display module, a display, or a panel) is exposed forward (outward) from the housing 3 through the opening 3r, for example. A user can view the display screen 4a from the front side through the opening 3r. The display 4 is formed in a rectangular shape (an oblong shape in the first embodiment, for example) viewed from the front. Furthermore, the display 4 is formed in a flat rectangular parallelepiped shape that has a small width in the front-back direction. The display 4 is a liquid crystal display (LCD) or an organic electro-luminescent display (GELD), for example.

In the first embodiment, for example, the front side (face side or wall 3k side) of the display 4 is provided with an input operation panel 5 (e.g., a touch panel, a touch sensor, or an operation surface). The input operation panel 5 is transparent and formed in a relatively thin rectangular shape, and covers the display screen 4a. An operator (e.g., a user) performs, for example, an operation, such as a touch, a press, and a slide on the input operation panel 5 using his or her fingers or a component (e.g., a stylus, which is not illustrated) or an operation, such as a movement of his or her fingers, a stylus, or the like in the vicinity of the input operation panel 5, thereby performing input processing. Furthermore, light output from the display screen 4a of the display 4 passes through the input operation panel 5 and is output forward (outward) from the housing 3 through the opening 3r of the wall 3k. The input operation panel 5 is an example of an input module.

In the first embodiment, as illustrated in FIG. 1, the housing 3 houses one or more circuit boards 6 (boards, control boards, main boards, electrical components, or first electrical components) on the rear side (other side, back side, wall 3m side, or side opposite to the display screen 4a) of the display 4, for example. The circuit board 6 is provided in a manner nearly parallel to the display 4. The circuit board 6 is provided in a manner separated from the walls 3k, 3m, and 3n, that is, with a space (a gap) interposed between the circuit board 6 and the walls 3k, 3m, and 3n, for example.

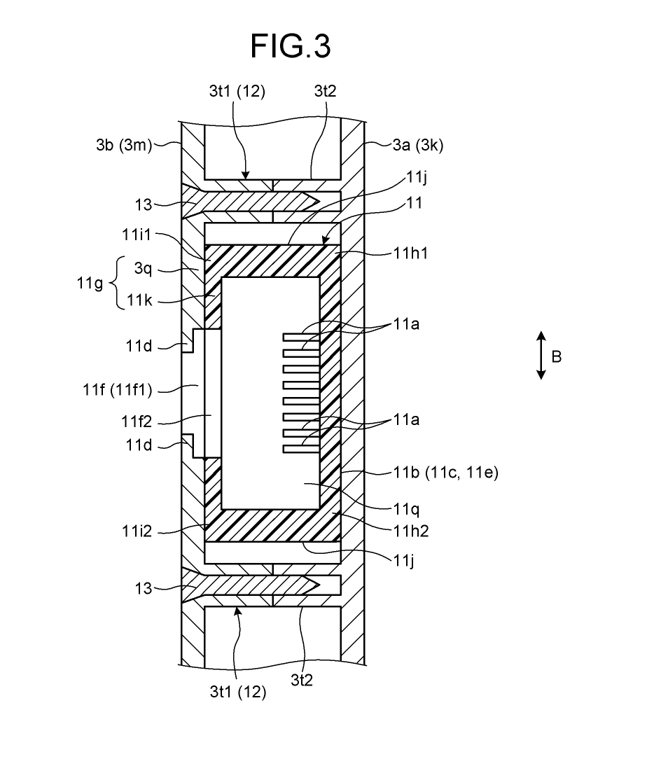

In the first embodiment, for example, a plurality of components (not illustrated), such as a central processing unit (CPU), a graphic controller, a power circuit component, a platform controller hub (PCH), a memory slot connector, an LCD connector, an input/output (I/O) connector, a power coil, an element, and a connector, can be mounted on the circuit board 6. Furthermore, a connector 11 (refer to FIGS. 3 and 4) is mounted on the circuit board 6, for example. A control circuit can comprise a video signal processing circuit, a tuner, a high-definition multimedia interface (HDMI) signal processor, an audio video (AV) input terminal, a remote-control signal receiver, a controller, a selector, an on-screen display interface, a storage module (e.g., a read-only memory (ROM), a random access memory (RAM), a hard disk drive (HDD), and a solid state drive (SSD)), and a voice signal processing circuit, for example. The control circuit controls output of video (a moving image, a still image, and the like) by the display screen 4a of the display 4, output of sound by a speaker (not illustrated), and emission of light by a light emitting diode (LED, which is not illustrated), for example. The display 4, the speaker, the LED, and the like are examples of an output module.

The connector 11 (a connecting device or a female connector) illustrated in FIG. 3 and FIG. 4 is a modular jack conforming to the RJ-45 standard, for example. The connector 11 is used for data communications, for example. Alternatively, the connector 11 maybe used for telephone communications. The connector 11 is exposed through an opening 3s (a second opening, refer to FIG. 2 and FIG. 4) provided to the wall 3n of the housing 3. An external connector 100 (FIG. 4) is inserted into the connector 11.

The connector 11 comprises a terminal 11a (a terminal module, a connecting module, or a conductive module), a base portion 11b (a housing portion or an attachment portion), and the hook 11d (second hook). The terminal 11a is electrically connected to (a terminal of) the external connector 100. The terminal 11a is provided in plurality (eight terminals 11a are provided in the first embodiment). The base portion 11b comprises an electrically insulated holder 11c holding the terminal 11a. The base portion 11b is made of a different member (a different component) from that of the housing 3. The base portion 11b is positioned between the wall 3m and the wall 3k. The hook 11d is provided to (the wall 3m of) the housing 3. A hook 100m of the external connector 100 engages with the hook 11d. As described above, a part of the connector 11 is comprised in the housing 3.

The connector 11 is in a nearly rectangular parallelepiped shape, for example. The connector 11 comprises a wall 11e (a third wall), a wall 11g (a fourth wall), a wall 11j (a fifth wall), and a wall 11q (a seventh wall), for example.

The wall 11e extends along a direction in which the external connector 100 is inserted into the connector 11 (an arrow A direction in FIG. 4, which will be simply referred to as an insertion direction hereinafter), and is positioned in a manner separated from the wall 3m. The wall 11e comes into contact with the inner surface of the wall 3k. The wall 11e holds the terminals 11a. The terminals 11a are positioned in a manner aligned in the width direction of the connector 11 (an arrow B direction in FIG. 3) orthogonal to the insertion direction. The wall 11e is comprised in the holder 11c. The wall 11e is made of an electrically insulated material, such as a resin.

The wall 11g is positioned in a manner separated from the wall 11e on the wall 3m side of the wall 11e. The wall 11g has an opening 11f (a third opening, refer to FIGS. 3 and 5). At least a part of the wall 11g is provided to the first wall 3m, and at least a part of the opening 11f is provided to the wall 3m. The connector 11 is provided with a wall 11k (a sixth wall) that forms a part of the wall 11g and is overlapped with the wall 3m, for example. A portion 3q (a wall) of the wall 3m having the area overlapped with the wall 11k forms a part of the wall 11g. The portion 3q of the wall 3m is a portion in a dashed-dotted line of FIG. 5, for example. In other words, the wall 11g comprises the wall 11k and the portion 3q, for example. The wall 11k is made of an electrically insulated material, such as a resin. A handle 100b comprising the hook 100m of the external connector 100 is inserted into the opening 11f. The opening 11f is provided in a manner extending across the portion 3q of the wall 3m and the wall 11k. The opening 11f comprises an opening 11f1 provided to the portion 3q of the wall 3m and an opening 11f2 provided to the wall 11k. The opening 11f is in a nearly T-shape viewed from the surface 3b side of the wall 3m. The opening 11f communicates with the opening 3s.

The wall 11j is provided in a pair (two walls 11j are provided). The pair of walls 11j is positioned in a manner separated from each other in a direction (the arrow B direction in FIG. 3) orthogonal to the insertion direction and to a facing direction of the walls 11e and 11g. The pair of walls 11j connects ends 11h1 and 11h2 of the wall 11e in the direction orthogonal to the insertion direction and ends 11i1 and 11i2 of the wall 11g in the direction orthogonal to the insertion direction. The walls 11j are made of an electrically insulated material, such as a resin.

The wall 11q is provided to an end of the base portion 11b on the front side (far side) in the insertion direction. The wall 11q connects ends of the walls 11e, 11g, and 11j on the front side (far side) in the insertion direction. The wall 11q is provided with a slit (not illustrated) into which a part of the terminal 11a is inserted. The wall 11q is made of an electrically insulated material, such as a resin. In the first embodiment, the wall 11q forms the holder 11c together with the wall 11e. In other words, the holder 11c comprises the walls 11e and 11q. In the first embodiment, the holder 11c is in a nearly L-shape, for example.

As described above, the base portion 11b comprises the walls 11e, 11j, 11k, and 11q in the first embodiment.

In the first embodiment, as illustrated in FIG. 3, the connector 11 is positioned between a pair of connecting portions 12 that connects the walls 3m and 3k, for example. The connecting portion 12 comprises a boss 3t1 provided to the wall 3m, a boss 3t2 provided to the wall 3k, and a connection 13 (screw), for example. The connection 13 is inserted into the boss 3t1 and is connected to a screw (a female screw) provided in the boss 3t2. With this configuration, the accuracy in a relative position between the base portion 11b and the walls 3m and 3k is improved.

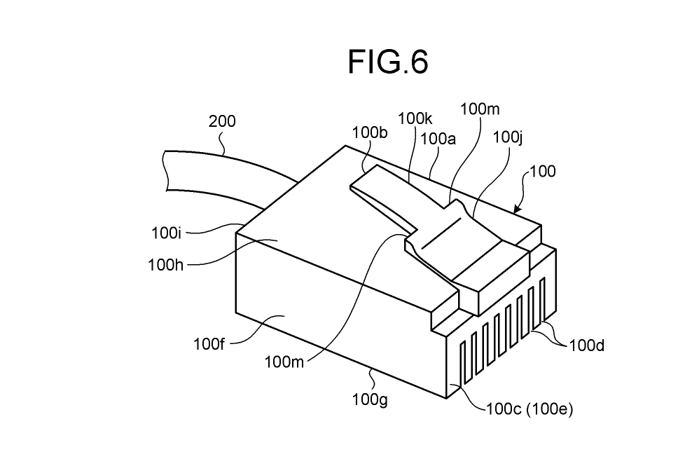

The external connector 100 (an external connecting device or a male connector) illustrated in FIG. 6 is a modular plug conforming to the RJ-45 standard, for example.

The external connector 100 comprises a main body 100a and the handle 100b (a lever or a movable portion) provided to the main body 100a. The main body 100a is in a nearly rectangular parallelepiped shape. The main body 100a is made of an electrically insulated material, such as a resin material. A plurality of terminals (not illustrated) are provided to the main body 100a in a manner aligned in the width direction of the main body 100a with a space interposed between the terminals. An end 100c (one end) of the main body 100a on the front side in the insertion direction is provided with a slit 100d corresponding to each terminal. The slit 100d is provided in a manner extending across a surface 100e (a surface) of the main body 100a on the front side in the insertion direction and a surface 100g (a bottom surface) forming a part of an outer surface 100f of the main body 100a. Each terminal is positioned in the corresponding slit 100d and is exposed therethrough. When the external connector 100 is attached to the connector 11, the terminal of the external connector 100 is connected (electrically connected) to the terminal 11a of the connector 11. Each terminal is connected to a cable 200.

The handle 100b is provided to a surface 100h forming the outer surface 100f of the main body 100a and positioned opposite to the surface 100g. The handle 100b extends at a predetermined gradient (inclination) from the end 100c of the main body 100a on the front side to an end 100i of the main body 100a on the rear side in the insertion direction. A base end portion (an end on the main body 100a side) of the handle 100b is integrated with the main body 100a, and the handle 100b is cantilevered by the main body 100a. The handle 100b is made of a material, such as a resin. The handle 100b is elastically deformable in directions coming into contact with and separated from a surface 100i. The handle 100b comprises a wide portion 100j (a part) comprising the base end portion and a narrow portion 100k (a part) extending from the wide portion 100j and comprising a tip of the handle 100b. An end of the wide portion 100j on the narrow portion 100k side is provided with the hook 100m. The hook 100m is provided in a pair with the narrow portion 100k sandwiched therebetween.

The external connector 100 is inserted into the base portion 11b of the connector 11 and is connected to the connector 11. In the insertion process, for example, the wide portion 100j of the handle 100b is pushed in a direction closer to the surface 100h by the hook 11d of the base portion 11b and passes under (passes through) the hook 11d. After the wide portion 100j passes under the hook 11d, the handle 100b is elastically recovered (restored), thereby causing the hook 100m to engage with the hook 11d. More specifically, the hook 100m passing through the opening 11f engages with the hook 11d. In this state, the external connector 100 is held by the base portion 11b in a manner prevented from coming out by the hook 11d.

By contrast, to remove the external connector 100 from the connector 11, for example, the operator pushes the wide portion 100j of the handle 100b in the direction closer to the surface 100h and removes the hook 100m from the hook 11d. In this state, the external connector 100 is pulled out from the base portion 11b of the connector 11.

As described above, the connector 11 according to the first embodiment comprises the terminal 11a, the base portion 11b, and the hook 11d. The terminal 11a is electrically connected to the external connector 100. The base portion 11b comprises the electrically insulated holder 11c holding the terminal 11a and is made of a different member from that of the housing 3. The hook 11d is provided to the housing 3, and the hook 100m of the external connector 100 engages therewith.

The television receiver 1 (electronic apparatus) comprises the housing 3, the circuit board 6 housed in the housing 3, the connector 11 that is mounted on the circuit board 6 and to which the external connector 100 is connected, and the hook 11d that is provided to the housing 3 and with which the hook 100m of the external connector 100 engages.

In the first embodiment, the hook 11d of the connector 11 is provided to (comprised in) the housing 3. Therefore, according to the first embodiment, the television receiver 1 can be made smaller (thinner).

### First Modification

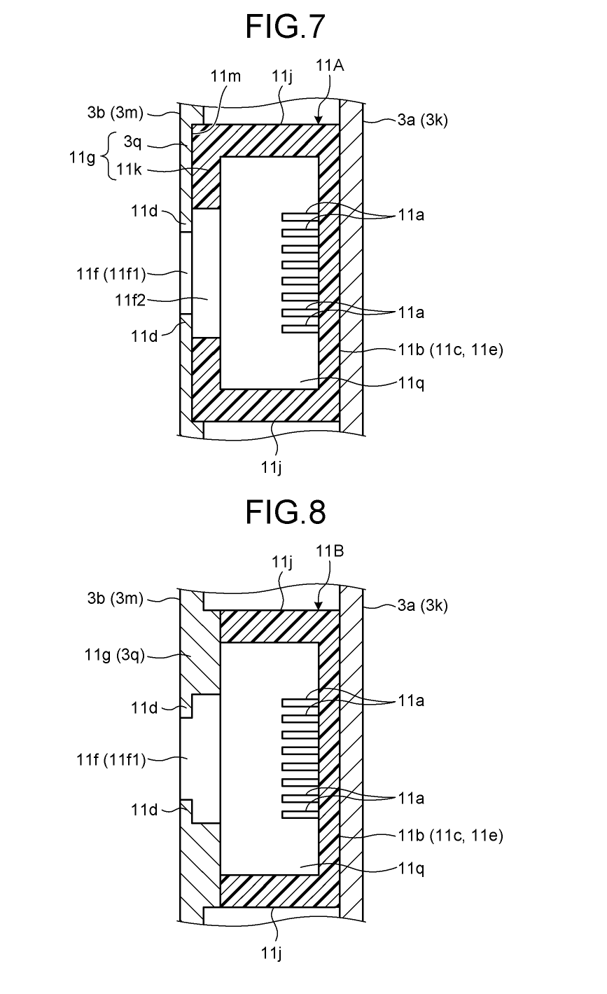

As illustrated in FIG. 7, in a connector 11A according to a first modification of the first embodiment, the wall 3m is provided with a recess 11m (a first recess) into which the wall 11k (sixth wall) is inserted. The wall 11k is fit into the recess 11m and is positioned by the recess 11m, for example. According to the first modification, because the wall 11k is inserted into the recess 11m, the television receiver 1 can be made still smaller (thinner).

### Second Modification

As illustrated in FIG. 8, in a connector 11B according to a second modification of the first embodiment, the whole of the wall 11g is provided to the wall 3m. In other words, in the second modification, the wall 11g is formed of the portion 3q of the wall 3m. Therefore, according to the second modification, the structure of the base portion 11b can be simplified.

### Third Modification

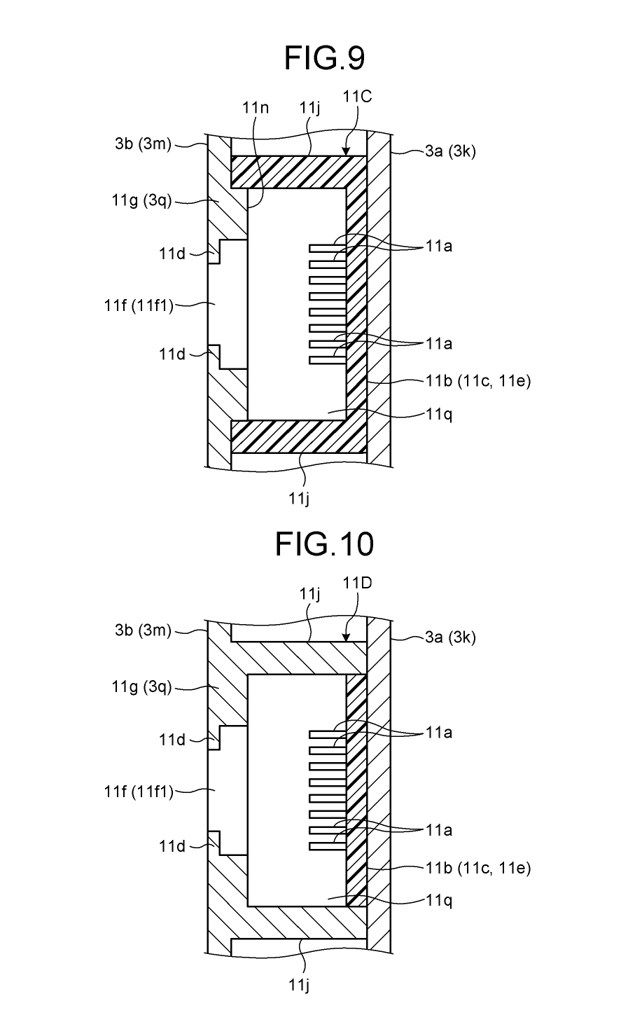

As illustrated in FIG. 9, a connector 11C according to a third modification of the first embodiment is different from that of the second modification in that a protrusion 11n is provided to the wall 3m. The protrusion 11n forms the wall 11g and is inserted (fit) between the pair of walls 11j. The pair of walls 11j is positioned by the protrusion 11n. Therefore, according to the third modification, the base portion 11b can be excellently positioned.

### Fourth Modification

As illustrated in FIG. 10, a connector 11D according to a fourth modification of the first embodiment is different from those of the second and the third modifications in that the pair of walls 11j is provided to (comprised in) the wall 3m. Therefore, according to the fourth modification, the structure of the base portion 11b can be simplified.

### Fifth Modification

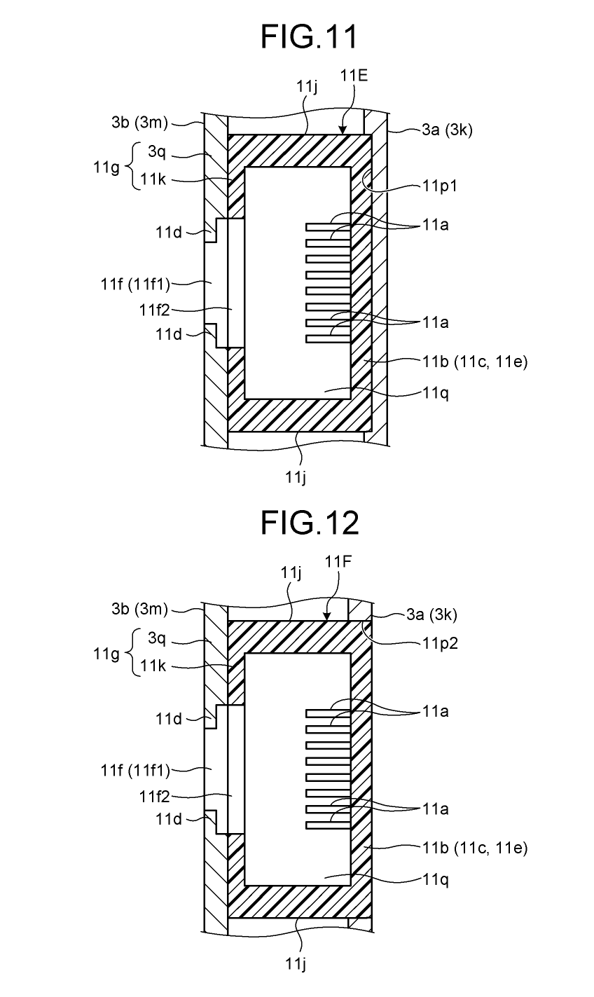

As illustrated in FIG. 11, in a connector 11E according to a fifth modification of the first embodiment, the wall 3k is provided with a recess 11p1 (a fourth opening) into which (the wall 11e of) the base portion 11b is inserted. Therefore, according to the fifth modification, the television receiver 1 can be made still smaller (thinner).

### Sixth Modification

As illustrated in FIG. 12, in a connector 11F according to a sixth modification of the first embodiment, the wall 3k is provided with a through hole 11p2 (the fourth opening) into which (the wall 11e of) the base portion 11b is inserted. Therefore, according to the sixth modification, the television receiver 1 can be made still smaller (thinner).

### Second Embodiment

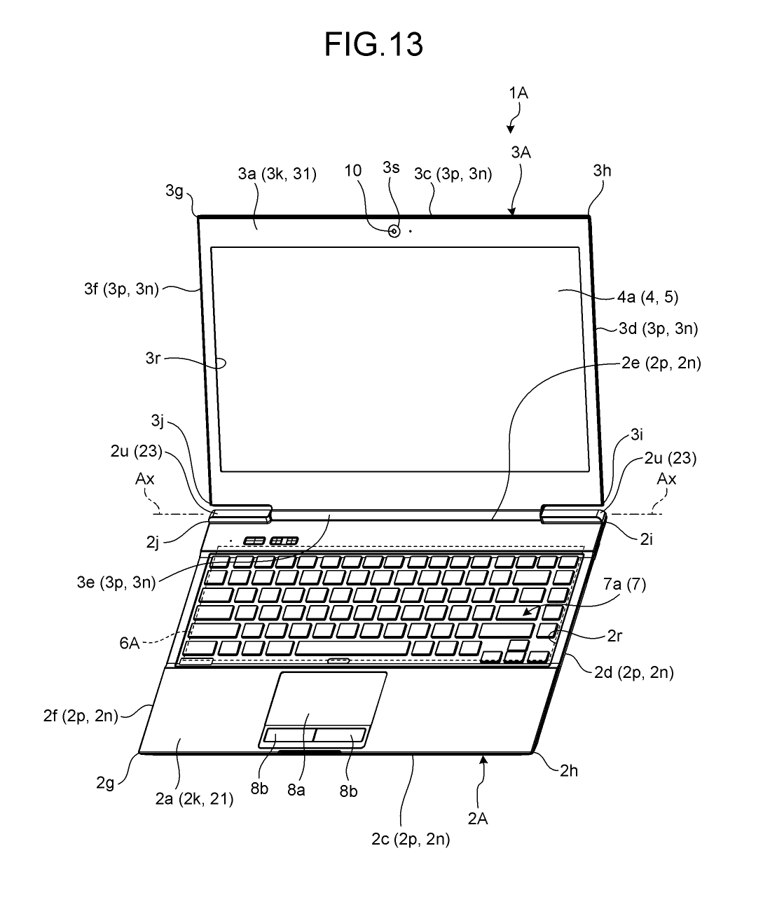

In a second embodiment, as illustrated in FIG. 13, an electronic apparatus 1A comprises a first housing 3A (a housing) and a second housing 2A, for example. Specifically, the first housing 3A (a first part) houses at least a part of a display 4. The second housing 2A houses a circuit board 6A. The second housing 2A is provided with a keyboard 7 (an input operation module, a first input operation module, an input receiving module, or an input module), a pointing device 8a (an input operation module, a second input operation module, an input receiving module, or an input module), and a click button 8b (an input operation module, a third input operation module, an input receiving module, or an input module), for example.

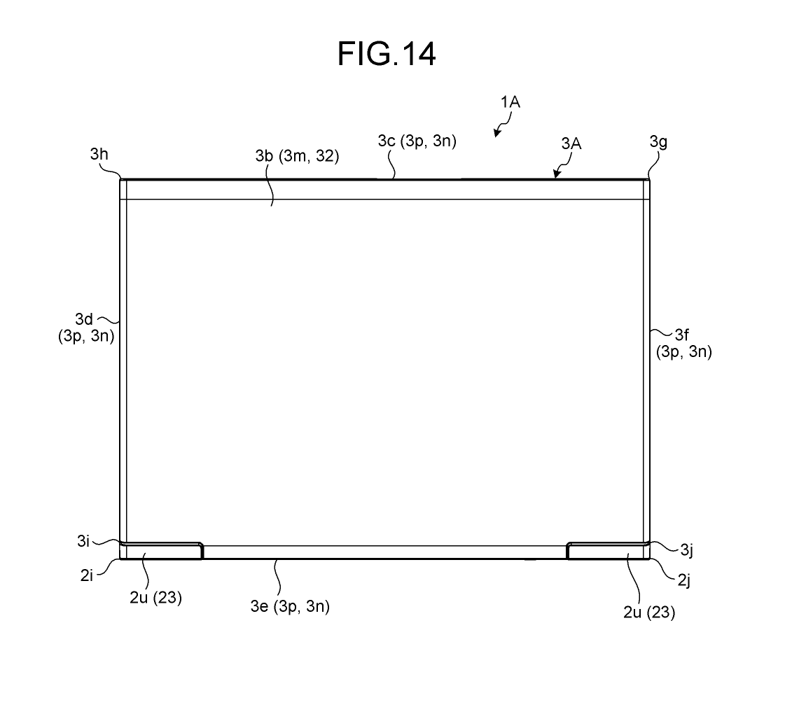

The first housing 3A is rotatably connected to the second housing 2A by a hinge (a connecting portion, a coupling portion, a rotational supporting portion, a hinge mechanism, a connecting mechanism, a coupling mechanism, or a rotational supporting mechanism). The first housing 3A and the second housing 2A are rotatably connected by the hinge at least between an unfolded state illustrated in FIG. 13 and a folded state illustrated in FIG. 14. In the second embodiment, for example, the hinge connects the first housing 3A and the second housing 2A in a rotatable manner about a rotation axis Ax. A display screen 4a of the display 4 is exposed through an opening 3r provided to a surface 3a (a front surface, a face, a first surface, or a first surface portion) of the first housing 3A. The keyboard 7, the pointing device 8a, the click button 8b, and the like are exposed on a surface 2a (an upper surface, a face, a first surface, or a first surface portion) of the second housing 2A. In the folded state, the surface 3a of the first housing 3A and the surface 2a of the second housing 2A overlap with each other, whereby the display screen 4a, the keyboard 7, the pointing device 8a, the click button 8b, and other components are hidden by the first housing 3A and the second housing 2A. In the unfolded state, the surface 3a of the first housing 3A and the surface 2a of the second housing 2A are exposed, whereby the display screen 4a, the keyboard 7, the pointing device 8a, the click button 8b, and other components can be used (can be viewed or can be operated).

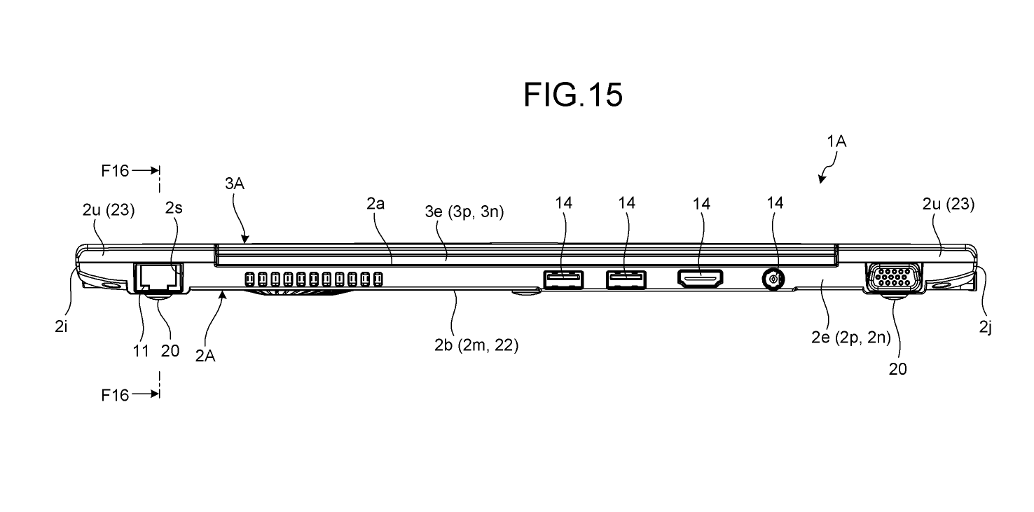

In the second embodiment, as illustrated in FIGS. 13 and 14, the first housing 3A is formed in a rectangular shape (an oblong shape in the second embodiment, for example) viewed from the front and the back, for example. Furthermore, in the second embodiment, as illustrated in FIG. 15, the first housing 3A is formed in a flat rectangular parallelepiped shape that has a small width in the front-back direction, for example. The first housing 3A comprises the surface 3a (a front surface, a face, a first surface, or a first surface portion) and a surface 3b (a rear surface, a back surface, a second surface, or a second surface portion) opposite thereto. The surface 3a and the surface 3b are nearly parallel to each other. Furthermore, as illustrated in FIG. 13, the first housing 3A comprises four ends 3c to 3f (sides or edges) and four corners 3g to 3j (peaks, curves, or ends) viewed from the front. The ends 3c and 3e are examples of a long side. The ends 3d and 3f are examples of a short side.

The first housing 3A further comprises a wall 3k (a plate, a frame, a front wall, a face wall, or a top wall) comprising the surface 3a and a wall 3m (a plate, a rear wall, a back wall, or a bottom wall) comprising the surface 3b. The walls 3k and 3m are in a rectangular shape (an oblong shape in the second embodiment, for example). Furthermore, the first housing 3A comprises four walls 3n (plates, side walls, end walls, standing walls, or extending portions) comprising a surface 3p (a side surface, a peripheral surface, or a third surface) extending between the wall 3k and the wall 3m. The wall 3k has the opening 3r in a rectangular shape, for example. Therefore, the wall 3k is in a rectangular shape and a frame shape.

Furthermore, the first housing 3A can be formed by combining a plurality of components (divided parts). In the second embodiment, for example, the first housing 3A comprises a first housing member 31 (a first part, a front side member, a mask, a mask portion, a cover, a front cover, a cover portion, or a first area) having at least the wall 3k and a second housing member 32 (a second part, a rear side member, a base, a base portion, a bottom, a bottom portion, a cover, a rear cover, a cover portion, or a second area) having at least the wall 3m. The wall 3n is comprised in at least one of the first housing member 31 and the second housing member 32 (e.g., in the second housing member 32). In addition to the first housing member 31 and the second housing member 32, the first housing 3A can comprise a third housing member (a middle member, a dividing member, a barrier member, a wall member, an intervening member, an inner plate, a middle plate, a middle frame, or a third area, which is not illustrated), a fourth housing member (a middle member, a dividing member, a barrier member, a wall member, an intervening member, a covering member, a shield, or a fourth area, which is not illustrated), and the like arranged between the first housing member 31 and the second housing member 32.

The first housing 3A can be made of a metal material and a synthetic resin material, for example. The first housing member 31 and the second housing member 32 can be made of a material having relatively low rigidity (a material having lower rigidity than those of the third housing member and the fourth housing member, such as a synthetic resin material). Surfaces of the first housing member 31 and the second housing member 32 facing the inside of the first housing 3A can be provided with a wall such as a rib (a protruding portion or a protruding wall, which is not illustrated). The wall can increase the rigidity of the first housing 3A.

In the second embodiment, as illustrated in FIG. 13, the surface 3a of the first housing 3A can be provided with a camera module 10 (a camera or a capturing device), for example. The camera module 10 and the like are exposed through an opening 3s provided to the wall 3k of the first housing 3A. The surface 3p of the first housing 3A can be provided with a connector and an operation module.

In the second embodiment, as illustrated in FIG. 13, the display screen 4a arranged on the surface 3a side of the display (a display module, a display, or a panel) is exposed forward (outward) from the first housing 3A through the opening 3r, for example. A user can view the display screen 4a from the front side through the opening 3r. The display 4 is formed in a rectangular shape (an oblong shape in the second embodiment, for example) viewed from the front. Furthermore, the display 4 is formed in a flat rectangular parallelepiped shape that has a small width in the front-back direction. The display 4 is an LCD or an GELD, for example.

In the second embodiment, for example, the front side (face side or wall 3k side) of the display 4 is provided with an input operation panel 5 (e.g., a touch panel, a touch sensor, and an operation surface). The input operation panel 5 is transparent and formed in a relatively thin rectangular shape, and covers the display screen 4a. An operator (e.g., a user) performs, for example, an operation, such as a touch, a press, and a slide on the input operation panel 5 using his or her fingers or a component (e.g., a stylus, which is not illustrated) or an operation, such as a movement of his or her fingers, a styrus, or the like in the vicinity of the input operation panel 5, thereby performing input processing. Furthermore, light output from the display screen 4a of the display 4 passes through the input operation panel 5 and is output forward (outward) from the first housing 3A through the opening 3r of the wall 3k. The input operation panel 5 is an example of an input module.

In the second embodiment, as illustrated in FIGS. 13 and 14, the second housing 2A is formed in a rectangular shape (an oblong shape in the second embodiment, for example) viewed from the front and the back, for example. Furthermore, in the second embodiment, as illustrated in FIG. 15, the second housing 2A is formed in a flat rectangular parallelepiped shape that has a small width in the front-back direction, for example. The second housing 2A comprises the surface 2a (an upper surface, a face, a first surface, or a first surface portion) and a surface 2b (a lower surface, a back surface, a second surface, or a second surface portion) opposite thereto. The surface 2a and the surface 2b are nearly parallel to each other. Furthermore, as illustrated in FIG. 13, the second housing 2A comprises four ends 2c to 2f (sides or edges) and four corners 2g to 2j (peaks, curves, or ends) viewed from the front. The ends 2c and 2e are examples of a long side. The ends 2d and 2f are examples of a short side.

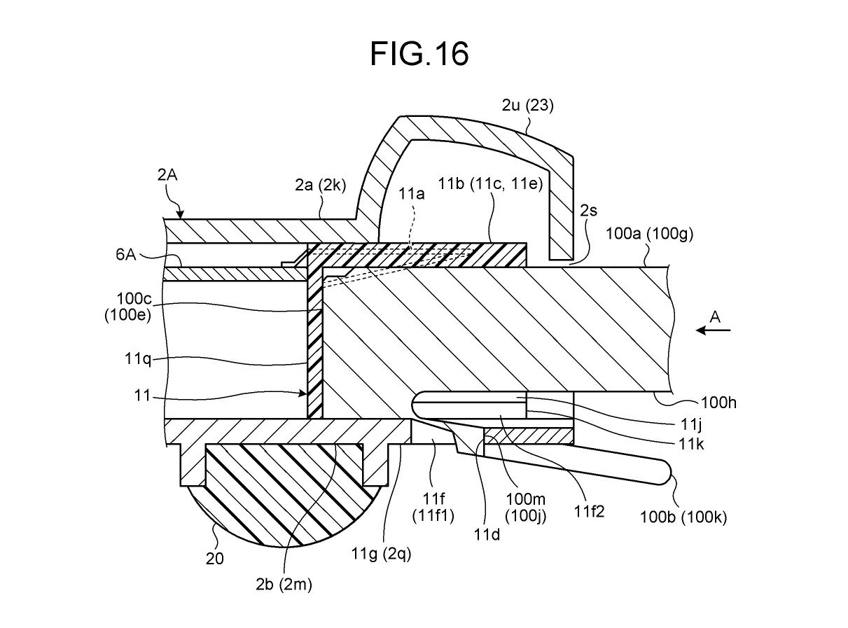

The second housing 2A further comprises a wall 2k (a plate, a frame, a front wall, a face wall, or a top wall) comprising the surface 2a and a wall 2m (a plate, a rear wall, a back wall, or a bottom wall, refer to FIG. 15) comprising the surface 2b. The walls 2k and 2m are in a rectangular shape (an oblong shape in the second embodiment, for example). Furthermore, the second housing 2A comprises four walls 2n (third parts, plates, side walls, end walls, standing walls, or extending portions) comprising a surface 2p (a side surface, a peripheral surface, or a third surface) extending between the wall 2k and the wall 2m. The wall 2k has an opening 2r in a rectangular shape, for example. Therefore, the wall 2k is in a rectangular shape and a frame shape. The wall 2m is an example of a first wall (a first part) provided with a hook 11d (a second hook, refer to FIG. 16), and the wall 2k is an example of a second wall (a second part) facing the wall 2m (first wall) with a space interposed therebetween.

Furthermore, the second housing 2A can be formed by combining a plurality of components (divided parts). In the second embodiment, for example, the second housing 2A comprises a first housing member 21 (a first part, a front side member, a mask, a mask portion, a cover, a front cover, a cover portion, or a first area, refer to FIG. 13) having at least the wall 2k and a second housing member 22 (a rear side member, a base, a base portion, a bottom, a bottom portion, a cover, a rear cover, a cover portion, or a second area, refer to FIG. 15) having at least the wall 2m. The wall 2n is comprised in at least one of the first housing member 21 and the second housing member 22 (e.g., in the second housing member 22). In addition to the first housing member 21 and the second housing member 22, the second housing 2A can comprise a third housing member (a middle member, a dividing member, a barrier member, a wall member, an intervening member, an inner plate, a middle plate, a middle frame, or a third area, which is not illustrated), a fourth housing member (a middle member, a dividing member, a barrier member, a wall member, an intervening member, a covering member, a shield, or a fourth area, which is not illustrated), and the like arranged between the first housing member 21 and the second housing member 22.

The second housing 2A can be made of a metal material and a synthetic resin material, for example. The first housing member 21 and the second housing member 22 can be made of a material having relatively low rigidity (a material having lower rigidity than those of the third housing member and the fourth housing member, such as a synthetic resin material). Surfaces of the first housing member 21 and the second housing member 22 facing the inside of the second housing 2A can be provided with a wall such as a rib (a protruding portion or a protruding wall, which is not illustrated). The wall can increase the rigidity of the second housing 2A.

The wall 2m of the second housing 2A is provided with a support 20 (a leg portion, a leg, or a rubber member) that supports the second housing 2A. The support 20 is provided to each of the four corners 2g to 2j, for example. The support 20 protrudes from the surface 2b. The support 20 is made of an elastic member, such as a rubber. The support 20 is placed on an external placing surface. The support 20 supports the second housing 2A in a manner placed on an external placing surface 200.

In the second embodiment, as illustrated in FIG. 13, an operation surface 7a (a surface or an upper surface) of the keyboard 7 is exposed forward (outward) from the second housing 2A through the opening 2r, for example. On the surface 2a, the keyboard 7 is positioned closer to the end 2e, and the pointing device 8a and the click button 8b are positioned closer to the end 2c opposite to the end 2e. The end 2e is positioned on the far side in the depth direction (front-back direction), and the end 2c is positioned on the near side.

In the second embodiment, as illustrated in FIG. 13, the second housing 2A houses one or more circuit boards 6A (circuit boards, control boards, main boards, electrical components, or first electrical components) on the rear side (other side, back side, wall 2m side, or side opposite to the operation surface 7a) of the keyboard 7, for example. The circuit board 6A is provided in a manner nearly parallel to the keyboard 7. The circuit board 6A is provided in a manner separated from the walls 2k, 2m, and 2n, that is, with a space (a gap) interposed between the circuit board 6A and the walls 2k, 2m, and 2n, for example.

In the second embodiment, for example, a plurality of components (not illustrated), such as a CPU, a graphic controller, a power circuit component, a PCH, a memory slot connector, an LCD connector, an I/O connector, a power coil, an element, and a connector, can be mounted on the circuit board 6A. A connector 11 is mounted on the circuit board 6A. A control circuit can comprise a video signal processing circuit, a tuner, an HDMI signal processor, an AV input terminal, a remote-control signal receiver, a controller, a selector, an on-screen display interface, a storage module (e.g., a ROM, a RAM, an HDD, and an SSD), and a voice signal processing circuit, for example. The control circuit controls output of video (a moving image, a still image, and the like) by the display screen 4a of the display 4, output of sound by a speaker (not illustrated), and emission of light by an LED (not illustrated), for example. The display 4, the speaker, the LED, and the like are examples of an output module.

In the second embodiment, as illustrated in FIGS. 13 and 14, a protruding portion 2u protruding from the surface 2a in the thickness direction is provided to both ends in the longitudinal direction of the end 2e of the second housing 2A, for example. In the second embodiment, as illustrated in FIGS. 14 and 15, a part of a hinge (a part on the second housing 2A side) is housed in the protruding portion 2u, for example. In the second embodiment, as illustrated in FIG. 15, the connector 11 having a larger height (thickness) than those of other connectors 14 is provided in a manner corresponding to the protruding portion 2u, for example. In the second embodiment, for example, the hinge is provided adjacent to the connector 11 in the protruding portion 2u. Furthermore, as illustrated in FIG. 15, a hinge cap 23 is provided adjacent to the connector 11. As a result, the height (thickness) of the part to which the connector 11 having a large height (thickness) is provided in the electronic apparatus 1A can be made smaller than that in the case where a wall of the second housing 2A is provided between the connector 11 and the hinge or between the connector 11 and the hinge cap 23, for example. Furthermore, the protruding portion 2u that houses the hinge is covered with the hinge cap 23 (a cover, a cap, a covering portion, a covering member, or a fifth housing member) that is a different component from the first housing member 21 and the second housing member 22. As a result, it is possible to facilitate separation of a process for assembling (attaching or dealing with) components around the hinge (e.g., the hinge, the connector 11, and a harness) from a process for assembling (attaching or dealing with) the first housing member 21 or the second housing member 22. Therefore, trouble in manufacturing can be reduced, for example. Furthermore, by decorating the hinge cap 23 in a different manner from that for other portions (e.g., general portions, the first housing members 21 and 31, and the second housing members 22 and 32), such as painting of the surface (outer surface) of the hinge cap 23 with a metallic paint, for example, it is possible to add an accent to the appearance.

As illustrated in FIG. 16, for example, the connector 11 is positioned between the wall 2m (first wall) and the wall 2k (second wall) of the second housing 2A and is exposed through an opening 2s. Because the connector 11 is basically similar to that in the first embodiment, differences from the first embodiment will be mainly explained in the description below. One of the connectors 11A to 11F may be applied to the second embodiment instead of the connector 11.

A base portion 11b of the connector 11 is positioned between the wall 2m and the wall 2k. The hook 11d is provided to (the wall 2m of) the second housing 2A. As described above, a part of the connector 11 is comprised in the second housing 2A.

A wall 11e extends along a direction in which an external connector 100 is inserted into the connector 11, and is positioned in a manner separated from the wall 2m. The wall 11e comes into contact with the inner surface of the wall 2k.

A wall 11g is positioned in a manner separated from the wall 11e on the wall 2m side of the wall 11e. At least a part of the wall 11g is provided to the first wall 2m, and at least a part of an opening 11f is provided to the wall 2m. The connector 11 is provided with a wall 11k (a sixth wall) that forms a part of the wall 11g and is overlapped with the wall 2m, for example. A portion 2q (a wall) of the wall 2m having the area overlapped with the wall 11k forms a part of the wall 11g. In other words, the wall 11g comprises the wall 11k and the portion 2q, for example. The opening 11f is provided in a manner extending across the portion 2q of the wall 2m and the wall 11k. The opening 11f comprises an opening 11f1 provided to the portion 2q of the wall 2m and an opening 11f2 provided to the wall 11k. The opening 11f communicates with the opening 2s.

In the second embodiment, for example, the connector 11 is arranged at a position where the connector 11 overlaps with the support 20 (support 20 arranged at the corner 2j) above the support 20 (support 20 arranged at the corner 2j) when the support 20 (support 20 arranged at the corner 2j) is placed on the external placing surface.

In the second embodiment, the hook 11d of the connector 11 is provided to (comprised in) the second housing 2A. Therefore, the electronic apparatus 1A can be made smaller (thinner).

### Third Embodiment

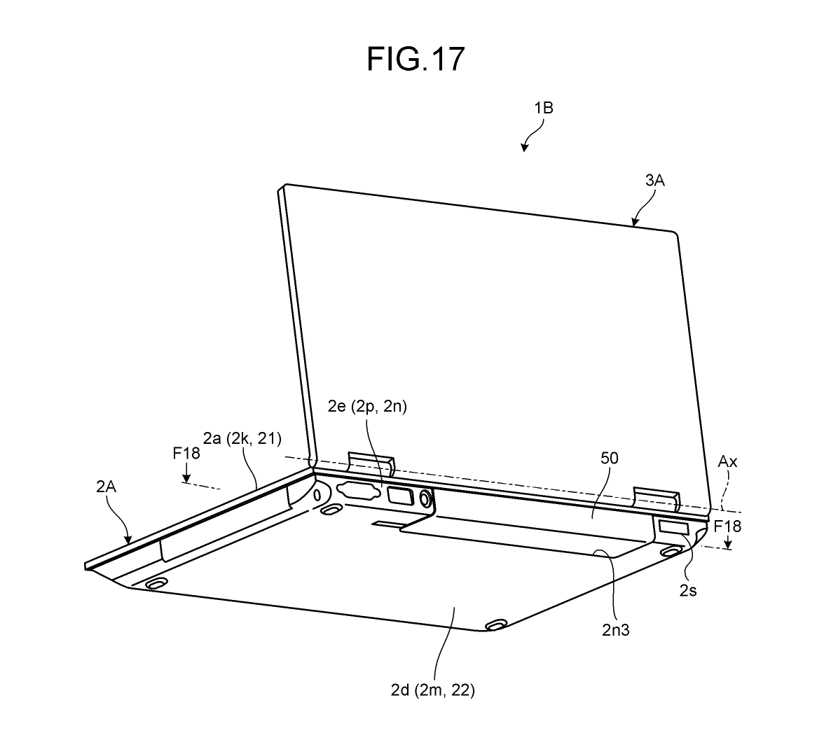

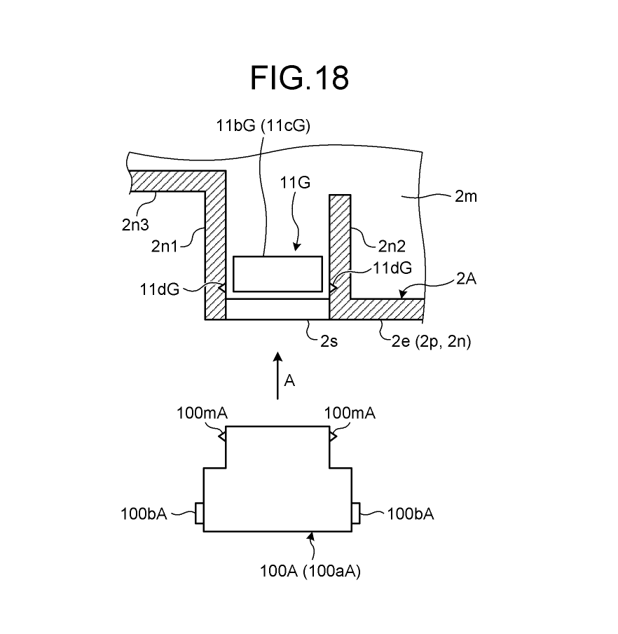

As illustrated in FIG. 17, an electronic apparatus 1B according to a third embodiment comprises a first housing 3A (a housing) and a second housing 2A similarly to the electronic apparatus 1A. The electronic apparatus 1B according to the third embodiment is different from that of the second embodiment in that a connector 11G (refer to FIG. 18) is provided instead of the connector 11. An external connector 100A is inserted into the connector 11G, whereby the connector 11G is electrically connected to the external connector 100A. The connector 11G forms a display port, for example.

As illustrated in FIG. 18, the connector 11G is exposed through an opening 2s provided to the second housing 2A. The connector 11G comprises a terminal (a terminal module, a connecting module, or a conductive module, which is not illustrated), a base portion 11bG (a housing portion or an attachment portion), and a hook 11dG (a second hook). The terminal is electrically connected to (a terminal of) the external connector 100A. The base portion 11bG comprises an electrically insulated holder 11cG holding the terminal. The base portion 11bG is made of a different member (a different component) from that of the second housing 2A. The base portion 11bG is positioned between a wall 2m and a wall 2k. The hook 11dG is provided to the second housing 2A. More specifically, the hook 11dG is provided to walls 2n1 and 2n2 of the second housing 2A. The wall 2n1 is comprised in a wall 2n, and the wall 2n2 extends toward inside of the second housing 2A from the wall 2n. A hook 100mA of the external connector 100A engages with the hook 11dG. As described above, a part of the connector 11G is comprised in the second housing 2A.

The external connector 100A comprises a main body 100aA, a handle 100bA attached to the main body 100aA, and the hook 100mA connected to the handle 100bA. The main body 100aA is made of an electrically insulated material, such as a resin material. The main body 100aA is provided with a terminal (not illustrated). When the external connector 100A is attached to the connector 11G, the terminal of the external connector 100A is connected (electrically connected) to the terminal of the connector 11G. Each terminal is connected to a cable (not illustrated).

The handle 100bA is provided on both sides of the main body 100aA and can protrude and recede from and into the main body 100aA. The hook 100mA is provided before the handle 100bA on both sides of the main body 100aA. The hook 100mA can protrude and recede from and into the main body 100aA. By pushing the handle 100bA, the hook 100mA is housed in the main body 100aA.

The external connector 100A is inserted into the connector 11G and is connected to the connector 11G. In the insertion process, for example, an operator pushes the handle 100bA, thereby housing the hook 100mA in the main body 100aA. In this state, the external connector 100A is inserted into the connector 11G. If pushing of the handle 100bA is cancelled, the hook 100mA engages with the hook 11dG. In this state, the external connector 100A is held by the connector 11G in a manner prevented from coming out by the hook 11dG. By performing an inverse process, the external connector 100A is removed from the connector 11G.

In the third embodiment, as illustrated in FIG. 18, the wall 2n is provided with a recess 2n3 (an attachment portion). A battery 50 (refer to FIG. 17) is attached to the recess 2n3. The wall 2n1 forms a side wall of the recess 2n3.

In the third embodiment, the hook 11dG of the connector 11G is provided to (comprised in) the second housing 2A. Therefore, according to the third embodiment, the electronic apparatus 1B can be made smaller (thinner).

Furthermore, in the third embodiment, the connector 11G is provided next to the recess 2n3, and the hook 11dG is provided to the wall 2n1 forming the side wall of the recess 2n3. Therefore, the space between the recess 2n3 and the connector 11G can be made narrower.

As described above, according to the embodiments, it is possible to downsize the television receiver 1 and the electronic apparatuses 1A and 1B.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television receiver comprising:
a housing comprising a first opening and a second opening;
a display in the housing, the display comprising a display surface exposed through the first opening;
a circuit board in the housing; and
a connector on the circuit board, exposed through the second opening, an external connector configured to be inserted into the connector, wherein
the connector comprises:
a terminal configured to be electrically connected to the external connector;
a base portion as a separate member from the housing, the base portion comprising an electrically insulated holder holding the terminal; and
a second hook as a part of the housing, a first hook of the external connector configured to engage with the second hook.

2. The television receiver of claim 1, wherein
the housing comprises a first wall comprising the second hook and a second wall facing the first wall with a space interposed therebetween, and
the base portion is between the first wall and the second wall.

3. The television receiver of claim 2, wherein
the connector comprises:
a third wall in the holder, the third wall extending along an insertion direction of the external connector, the third wall positioned separately from the first wall;
a fourth wall comprising a third opening into which a handle comprising the first hook of the external connector is configured to be inserted, the fourth wall positioned separately from the third wall on a side of the first wall of the third wall; and
a pair of fifth walls positioned separately from each other, the fifth walls connecting ends of the third wall in a direction orthogonal to the insertion direction and ends of the fourth wall in the direction orthogonal to the insertion direction,
at least apart of the fourth wall is configured to be provided to the first wall,
at least a part of the third opening is configured to be provided to the first wall, and
the first hook passing through the third opening is configured to engage with the second hook.

4. The television receiver of claim 3, wherein
the connector comprises a sixth wall comprising a part of the fourth wall, the sixth wall overlapped with the first wall, and
the first wall comprises a recess into which the sixth wall is configured to be inserted.

5. The television receiver of claim 3, wherein a whole of the fourth wall is configured to be provided to the first wall.

6. The television receiver of claim 5, wherein the first wall comprises a protrusion comprising the fourth wall, the protrusion inserted between the pair of fifth walls.

7. The television receiver of claim 3, wherein the pair of fifth walls is configured to be provided to the first wall.

8. The television receiver of claim 3, wherein the second wall comprises a fourth opening into which the base portion is inserted.

9. An electronic apparatus comprising:
a housing;
a circuit board in the housing;
a connector on the circuit board, an external connector configured to be connected to the connector; and
a second hook provided to the housing, a first hook of the external connector is configured to engage with the second hook.

10. A connector comprising:
a terminal configured to be electrically connected to an external connector;
a base portion as a separate member from a housing, the base portion comprising an electrically insulated holder holding the terminal; and
a second hook provided to the housing, a first hook of the external connector configured to engage with the second hook.
